(19) United States
(12) Patent Application Publication
(10) Pub. No.: US 2017/0201550 A1
(43) Pub. Date: Jul. 13, 2017

(54) CREDENTIAL STORAGE ACROSS MULTIPLE DEVICES

(71) Applicant: Apple Inc., Cupertino, CA (US)

(72) Inventors: Wade Benson, San Jose, CA (US); David M. O'Rourke, San Jose, CA (US); Michael D. Santos, Campbell, CA (US); Gopi K. Rangaswamy, Cupertino, CA (US); Selvarajan Subramaniam, Sunnyvale, CA (US); Timothy P. Hannon, Palo Alto, CA (US); Pierre-Olivier Martel, Mountain View, CA (US); Raghu Pai, Cupertino, CA (US); Andrew R. Whalley, San Francisco, CA (US); Michael Brouwer, Los Gatos, CA (US)

(21) Appl. No.: 15/274,880

(22) Filed: Sep. 23, 2016

Related U.S. Application Data
(60) Provisional application No. 62/276,939, filed on Jan. 10, 2016.

(51) Int. Cl. H04L 29/06

(52) U.S. Cl. CPC H04L 63/20; H04L 63/083

(57) ABSTRACT

Techniques are disclosed relating to accessing credential information on multiple devices. In one embodiment, a computer system is disclosed that includes one or processors and memory having program instructions stored therein that are executable by the one or more processors to cause the computer system to perform operations. The operations include storing registration information identifying a plurality of devices as being registered to an organization and receiving, over a network from a first device, a request for credential information of a first of a plurality of users associated with the organization. The operations further include authenticating the first request, including verifying that the first device is being used by the first user and determining, based on the registration information, whether the first device is one of the plurality of devices. The operations include granting or denying the first request for the credential information based on the authenticating.

This application claims the benefit of U.S. Prov. Appl. No. 62/276,939 filed on Jan. 10, 2016, which is incorporated by reference herein in its entirety.

### BACKGROUND

Technical Field

This disclosure relates generally to computing devices, and, more specifically, to authentication of a user to retrieve remotely stored information.

Description of the Related Art

In an effort to improve network security, many companies now place stricter requirements on passwords for accessing websites or other services. For example, a merchant might require a customer to have a password that includes 1) upper- and lower-case characters, 2) numeric characters, 3) one or more non-alphanumeric characters, and 4) a password exceeding eight characters in length. Moreover, companies are also advising users to not use the same password across multiple sites. Keeping track of multiple complex passwords can be difficult.

Various browsers now offer the ability to record password information in order to simplify tracking multiple passwords. For example, when a user enters a user name and password into a web form, a web browser may store this information after prompting the user to do so. When the user later returns to the site, the browser may populate the form, so that the user does not have to enter that information.

### SUMMARY

The present disclosure describes embodiments in which a credential storage system is used to store and distribute user credential information to users accessing multiple devices. In some embodiments, an organization registers devices with the credential storage system to establish an association of the devices with the organization. In such an embodiment, when a device attempts to retrieve credential information of a user, the device may issue a request for the credential information to the storage system over a network. The system may then authenticate the request by verifying authentication information of the user and, as an additional authentication factor, determining that the device is one of the devices registered to the organization. The system may then grant or deny the request for the credential information based on this authentication.

### BRIEF DESCRIPTION OF THE DRAWINGS

FIG. 1 is a block diagram illustrating one embodiment of a system for distributing credential information across multiple devices.

FIG. 2 is a block diagram illustrating one embodiment of a credential storage system in the distribution system.

FIGS. 3A-4C are block diagrams illustrating embodiments of provisioning, authentication, and restoration and backup using the credential storage system.

FIG. 5 is a block diagram illustrating one embodiment of authentication with a use code for unregistered devices.

FIG. 6 is a block diagram illustrating one embodiment of management hierarchy associated with the distribution system.

FIG. 7 is a flow diagram illustrating one embodiment of a method for distributing credential information across multiple devices with different password policies.

FIG. 8 is a block diagram illustrating one embodiment of an exemplary computer system.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “hardware security module configured to store credential information” is intended to cover, for example, a physical device that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus, the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. §112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, a computer system may have “first” and “second” users. The terms “first” and “second” are not limited to the initial users to use a computer system, but rather may refer to any users of the system.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

### DETAILED DESCRIPTION

In some instances, multiple devices may be shared among multiple users. For example, in a classroom setting, a teacher may hand tablet devices to multiple students for some activity. Later, the teacher may redistribute the devices to the students for another activity, but may distribute them in a manner different from before. As a student may be accessing multiple devices, storing that student's credential information on the devices can create potential issues. (As used herein, the term “credential information” (or simply “credentials”) refers generally to information that is usable to authenticate a user. For example, in various embodiments, credential information includes user names and passwords of a user. Additional examples of credential information include public and private keys used for authentication and encryption, transaction account information (e.g., a user's credit card number), Wi-Fi passwords, etc.) If a student enters credential information on a device that is given to another student, this other student may be able to access this information. Also, if a student enters new credential information or changes existing credential information on one device, the student may not be able to access this information on another device.

The present disclosure describes embodiments in which a system is used to securely distribute credential information to multiple devices. As will be described below, in various embodiment, this distribution system may include a credential storage system that is accessible to multiple devices over a computer network. When a user enters new credential information into a device, this information may be sent to the credential storage system, so that the user can retrieve this information at another device after being authenticated. In various embodiments, a given device may also be configured to store credential information of multiple users in an encrypted manner such that credential information of a given user is accessible to only that user.

In some embodiments, the distribution system may achieve a greater level of security by permitting an organization to register devices associated with the organization and to identify the users accessing the devices. For example, a school may register the devices that it intends to distribute to students of a class. The school may then identify the particular students in the class that will be accessing the devices. Accordingly, when a person later requests credential information at a device, the credential storage system may verify that the device is registered to the school and that the person has been identified as a student. If the person is not using a registered device or is not an identified user, in some embodiments, the person is denied access to the requested credential information.

In some embodiments, the greater level of security provided by verifying these additional authentication factors may allow a more relaxed password policy to be used when obtaining credential information. That is, the credential storage may have a stricter policy for passwords of users that are not using registered devices than a policy for passwords of users that are using registered devices. In some instances, having a relaxed password policy may be particularly beneficial for some users. For example, younger students at a school may struggle to remember more complicated passwords. In this example, a younger student using a register device might be permitted to use a four-digit numeric password as opposed to a more complicated password.

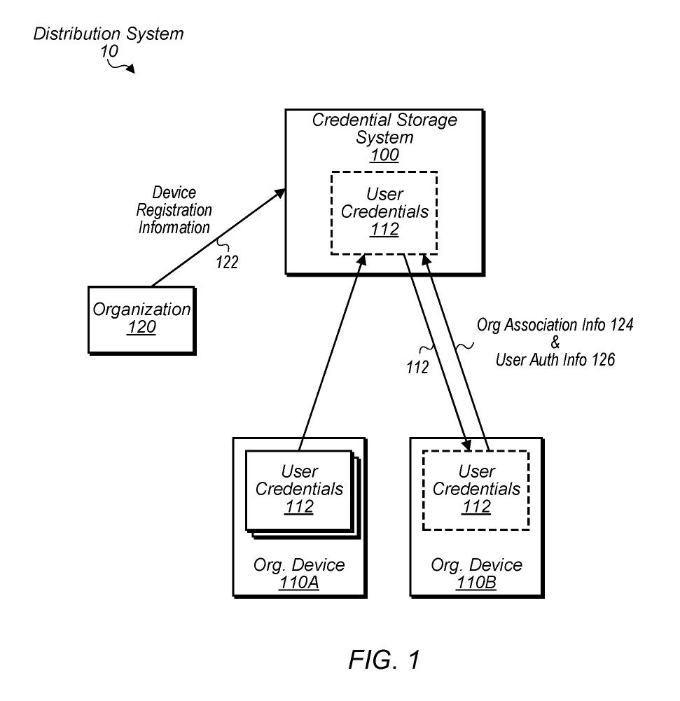

Turning now to FIG. 1, a block diagram of a distribution system 10 is depicted. In the illustrated embodiment, distribution system 10 includes a credential storage system 100, organization devices 110, and organization 120. In some embodiments, distribution system 10 may be implemented differently than shown. Accordingly, organization 120 may not be considered part of system 10. In some embodiments, system 10 may interact with multiple organizations 120, each having multiple organization devices 110. In some embodiments, system 10 may also include devices that are not associated with any organization 120.

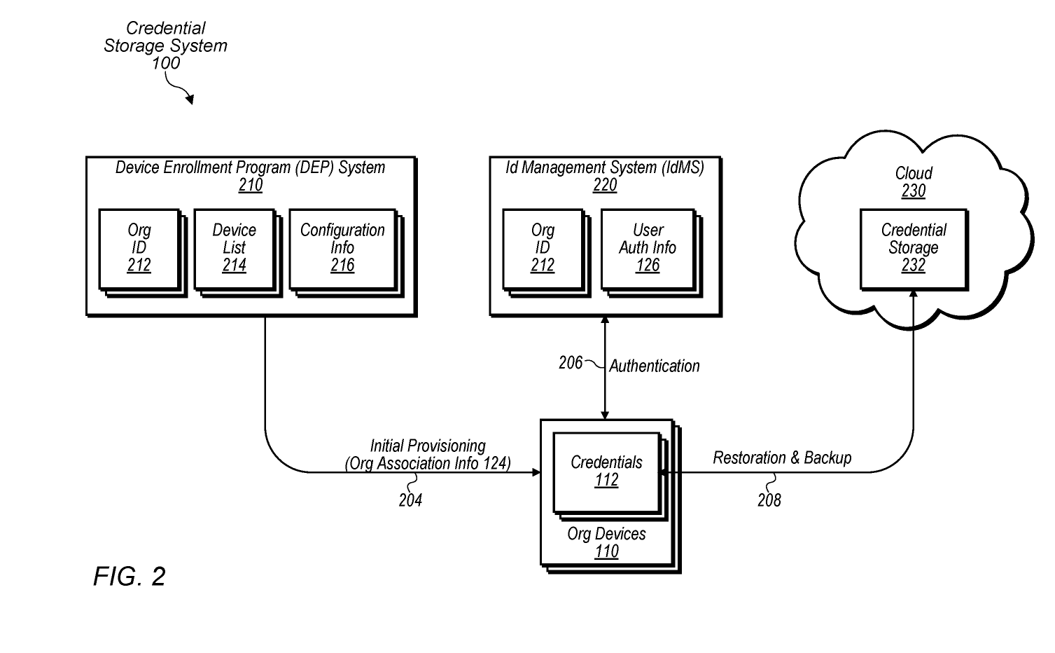

Credential storage system 100, in one embodiment, is a computer system configured to store user credentials 112. As noted above, user credentials 112 may include user names and passwords, which may be used, for example, to log into a website or an application on a device 110. Credentials 112 may include stored certificates for private and public keys, which may be used, for example, to authenticate a user through digital signatures, encrypt traffic associated with a user, such as virtual private network (VPN) traffic, etc. Credentials 112 may include transaction account information, such as credit card information, debit card information, gift card information, etc. Credentials 112 may also include network passwords, such as those used to connect to a Wi-Fi network. In various embodiments, credential storage system 100 is accessible to devices 110 over a computer network such as the Internet. In some embodiment, system 100 may store credentials 112 within a cloud-based storage as discussed with respect to FIG. 2.

Organization devices 110 may correspond to any suitable computing device. For example, in some embodiments, devices 110 include laptops, tablets, phones, watches, desktop computers, etc. In various embodiments, a given device 110 is configured to support access by multiple users. Accordingly, in some embodiments, a device 110 may implement multiple user accounts, each having a corresponding user name and password usable to unlock device 110. As used herein, the “unlock” refers generally to enabling functionality on a device in response to an authentication of a user. Unlocking may include, for example, logging into a device 110, permitting execution of an application on device 110, allowing use of a device peripheral, decrypting information so that it is accessible to a user, etc. In various embodiments, devices 110 are also configured to permit a given user to access multiple ones of devices 110. For example, a user may have an account that permits logging into both device 110A and device 110B.

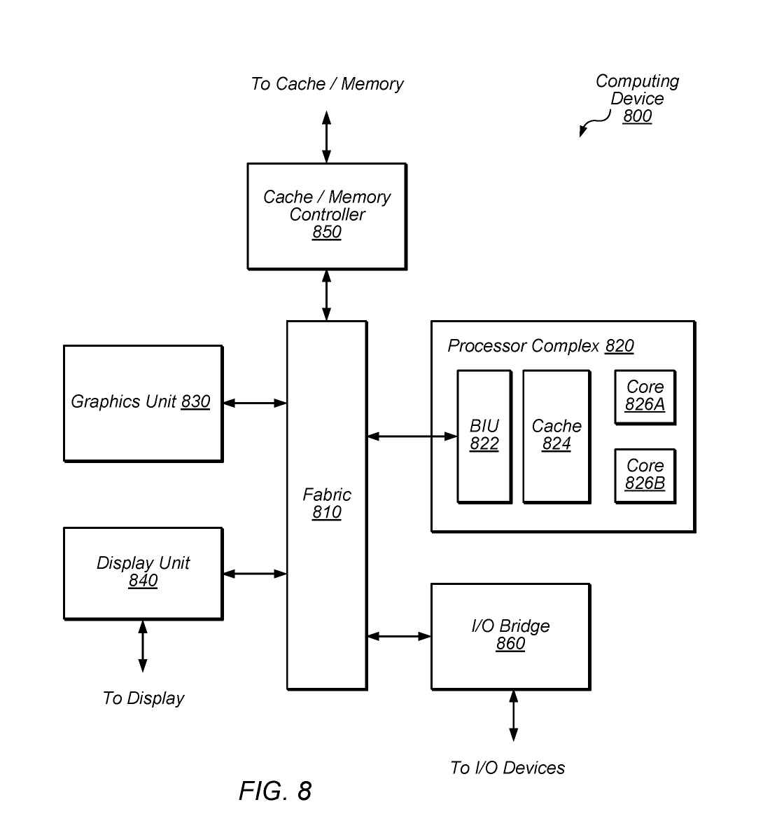

In various embodiments, devices 110 are configured to collect credentials 112 entered by a user and communicate those credentials 112 to storage system 100. Devices 110 may also be configured to retrieve and update credentials 112 stored in system 100. In various embodiment, devices 110 are configured to encrypt credentials 112 such that credentials 112 of a given user are accessible only to that user. For example, in one embodiment, each user's credentials 112 are encrypted using an encryption key derived from that user's password. In various embodiments, devices 110 are configured to implement functionality described herein by executing program instructions stored in a memory such as discussed below with respect to FIG. 8. In some embodiments, this software may be a web browser, other user application, and/or an operating system executing on devices 110.

Organization 120, in one embodiment, is an entity that is associated with devices 110 in some manner. Accordingly, in some embodiments, organization 120 owns devices 110. For example, organization 120 may be a school that purchased multiple devices 110 for students in a class. In some embodiments, devices 110 may be owned by users of organization 120. For example, devices 110 may be owned by employees of a company. As will be described in detail below with respect to FIG. 2, in various embodiments, organization 120 registers its devices 110 with credential storage system 100 by providing device registration information 122 to system 100. In some embodiments, information 122 may also identify the users that will be using devices 110.

In various embodiments, credential storage system 100 is configured to store information 122 and use this information to authenticate a user's request for credentials 112 from a device 110. For example, as shown in FIG. 1, a user may enter credentials 112 into a device 110A, which sends the credentials to storage system 100. When the user later attempts to retrieve those credentials 112 from another device 110B, in the illustrated embodiment, device 110B is configured to send both organization association information 124 and user authentication information 126 in order to authenticate the user.

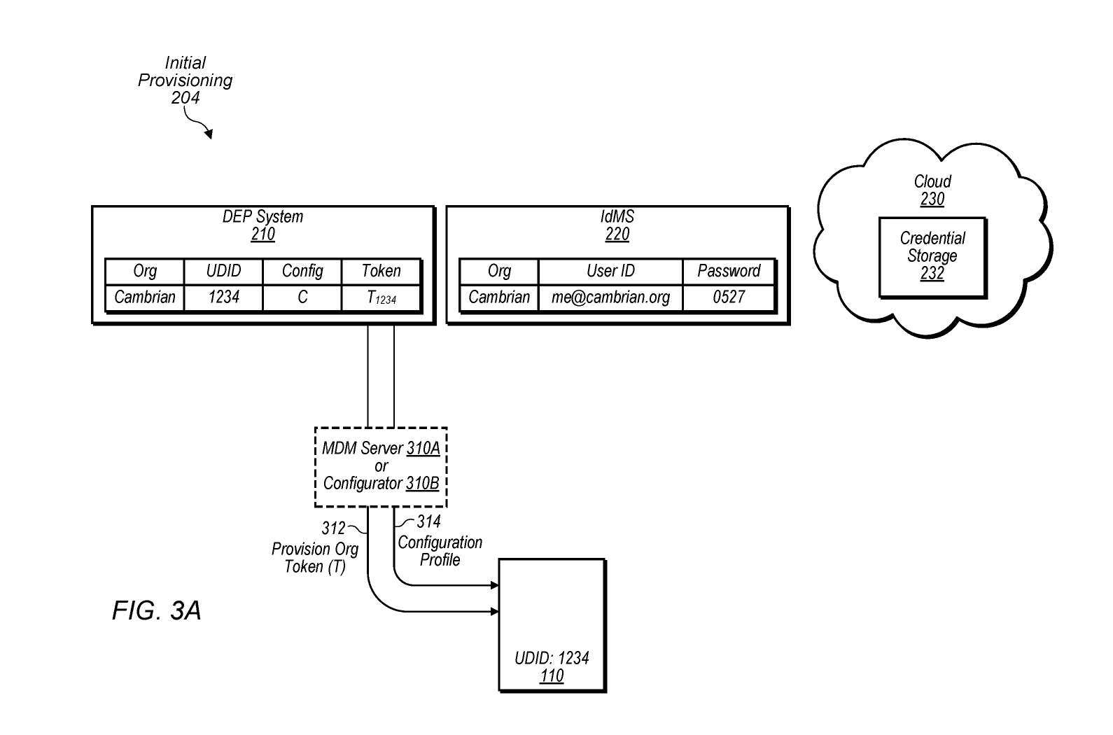

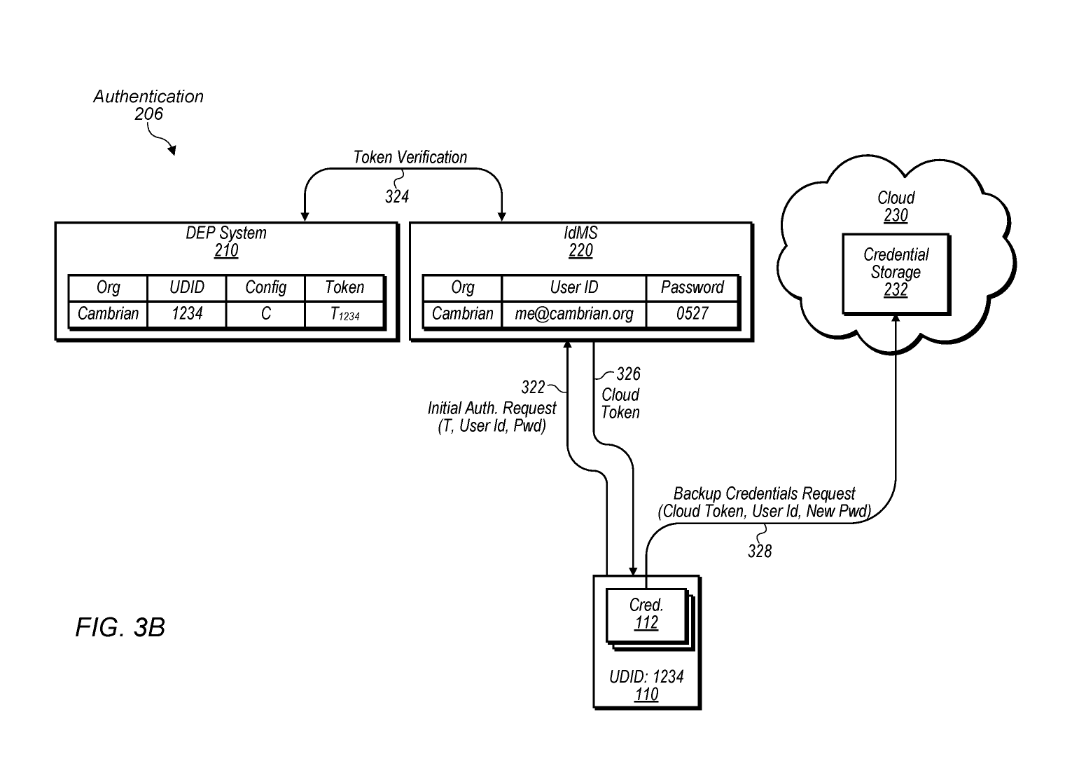

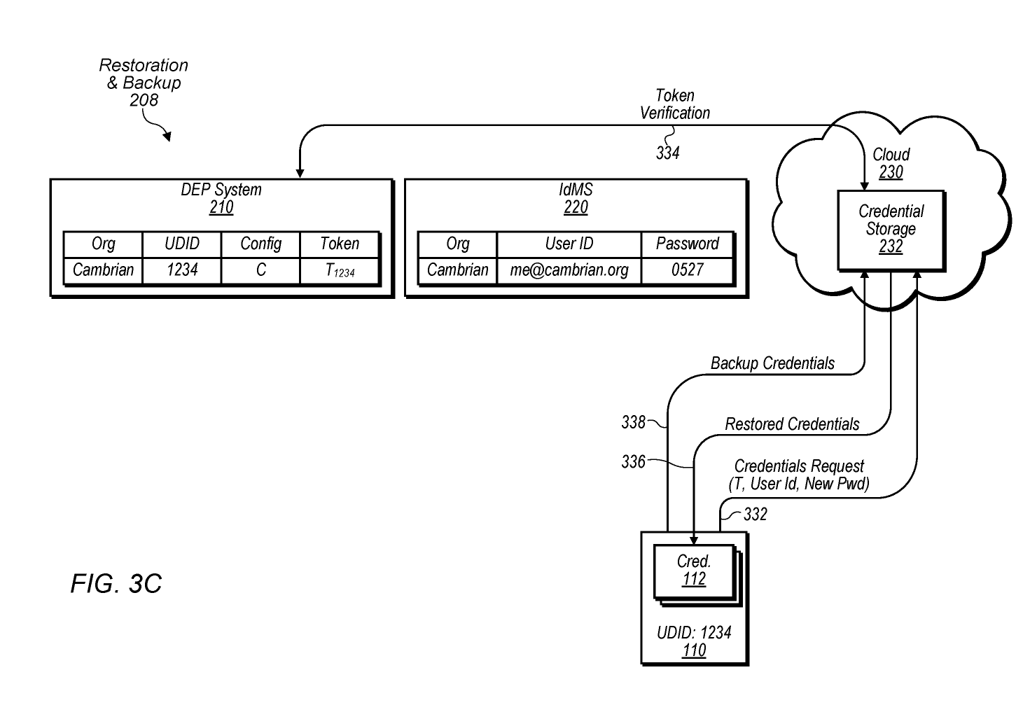

Organization association information 124, in one embodiment, is information that is usable to establish that device 110 is associated with organization 120. In some embodiments, this information 124 includes a unique identifier of a device 110, which is stored in the device 110 at fabrication and may be included in registration information 122 provided by organization 120. In some embodiments, information 124 is a token that establishes a device 100's association with organization 120 as discussed with FIG. 3A. In some embodiments, information 124 includes a digital signature generated by a private key stored in device 110; in such an embodiment, device registration information 122 may include the corresponding public key certificate usable by credential storage system 100 to verify the signature. In many instances, relying on a device 110′s association to organization 120 as an additional factor for authenticating a user can increase the security associated with retrieving credentials.

User authentication information 126, in one embodiment, is information that is usable to verify the identity of the user. In some embodiments, information 126 includes a user name and information indicative of a password of a user. That is, rather than convey a user's actual password from a device 110 to storage system 100, in such an embodiment, device 110 is configured to derive information from a received password and communicate the derived information in authentication information 126 to storage system 100, where system 100 is able to use the information to establish that the user is in possession of the password, and thus, authenticate the user. For example, in some embodiments, device 110 applies a one-way function (e.g., a hash function) to the password in order to derive another value (referred to below as a “verifier”) that is provided to system 100, which stores a copy of the value and compares the received copy of the value with the previously stored copy. In other embodiments, information 126 may include a user's password, but it may be encrypted in a manner that prevents it from being determined when its communication is observed by a third party.

In some embodiments, the user name and password are the same ones used to unlock devices 110. For example, in one embodiment, when a user enters a user name and password into a login screen, a device 110 is configured to capture this information and convey it, during the login process, as information 126 in a request for any credentials 112 on storage system 100. In some embodiments, the user name and/or the initial password for the user are established by organization 120 (or some entity other than the user such as system 100) and may be specified in information 122. In such an embodiment, establishing a user name and/or password in this manner creates an additional authentication factor, as a user must be made aware of this information before being able to authenticate with credential storage system 100.

In some embodiments, the added security provided by one or more of these additional factors may place less importance on having a stronger password for retrieving credentials 112. As a result, in some embodiments, credential storage system 100 is configured to permit simpler passwords for users using organization devices 110 than passwords for users using devices that are not associated with organization 120. As used herein, the term “simpler” refers to a password that has a shorter length than another password and/or is created from a smaller character set than the other password. For example, a password consisting of numeric characters is a simpler password than one consisting of alphanumeric characters even if the passwords have the same length. As noted above, a benefit of using simpler password is that they may be easier to remember—particularly for younger users, for example. In some embodiments, organization 120 may establish password policies that indicate whether simpler passwords are permissible for some (or all) users.

Turning now to FIG. 2, a block diagram of credential storage system 100 is depicted. In the illustrated embodiment, credential storage system 100 includes a device enrollment program (DEP) system 210, identifier management system (IdMS) 220, and cloud 230 with credential storage 232. In other embodiments, credential storage system 100 may be implemented differently than shown. For example, in one embodiment, systems 210 and 220 may not be distinct systems.

DEP system 210, in one embodiment, is a computer system configured to register devices 110 associated with an organization 120. In some embodiments, DEP system 210 is configured to provide a web-based interface to organization 120 for registering devices 110. That is, DEP system 210 may serve a website that allows an administrator to provide device registration information 122. In one embodiment, this website may permit the administrator to purchase additional devices 110, which are automatically associated with organization 120. When organization 120 registers with DEP system 210, in the illustrated embodiment, DEP system 210 is configured to store an organization identifier 212 that uniquely identifies organization 120 and a device list 214 of registered devices 110. In some embodiments, device list 214 includes a respective unique device identifier (UDID) for each registered device 110 and may be used during provisioning 204 and/or authentication 206 as discussed below. In some embodiments, DEP system 210 may allow an organization 120 to revoke a registration of a device 110 by removing its identifier from device list 214.

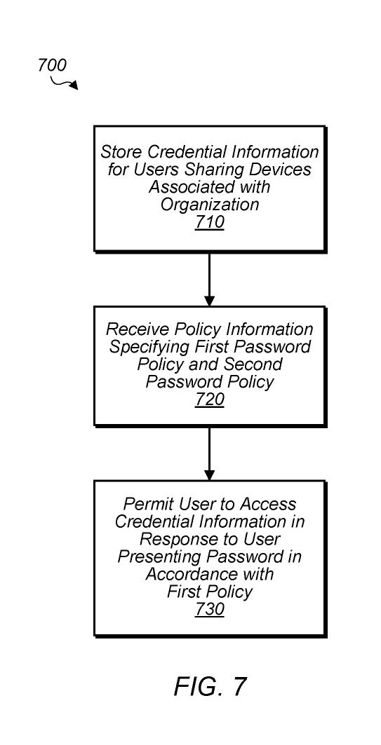

In various embodiments, DEP system 210 is also configured to store configuration information 216 specified by organization 120 for devices 110. In one embodiment, this information 216 includes one or more usage policies for devices 110 that control operation of devices 110. In some embodiments, such a policy may restrict which applications can be installed on device 110, particular operations that may be performed on a device 110, particular content that can be accessed by devices 110, etc. For example, a school may specify a usage policy that prevents installing game applications on devices 110 and prevents accessing social media websites. In some embodiments, information 216 may include one or more password policies specified by organization 120 that define criteria for permissible user passwords. For example, a password policy may specify a particular length for a password and the use of particular characters. In some embodiments, DEP system 210 is configured to allow organization 120 to specify multiple different password policies for devices 110 as discussed below with respect to FIG. 7.

In various embodiments, DEP system 210 is also configured to perform the initial provisioning 204 of devices 110. As shown, in the illustrated embodiment, provisioning 204 may include the storage of organization association information 124 on a device 110. In some embodiments, information 124 is generated in a manner that cryptographically binds a device 110 to organization 120. In one embodiment, system 210 is configured to generate a token by applying a keyed hash function (e.g., a message authentication code (MAC) in some embodiments) to organization identifier 212 and the device 110's UDID in device list 214—making the token unique to a given device 110. In one embodiment, the key used to create this token is known only to system 210 such that system 210 is the only entity capability of creating and validating any token created with that key. In another embodiment, the binding includes instructing a device 110 to generate a public key pair for generating and verifying digital signatures. DEP system 210 may also store the public key in a manner that is associated with device 110 such as storing the public key certificate with the corresponding UDID for the device 110 that generated the key. In some embodiments, provisioning 204 also includes storing configuration information 216 on a device 110. As will be discussed with FIG. 3A, this may include storing a profile on a device 110 that includes any usage policies and/or password policies.

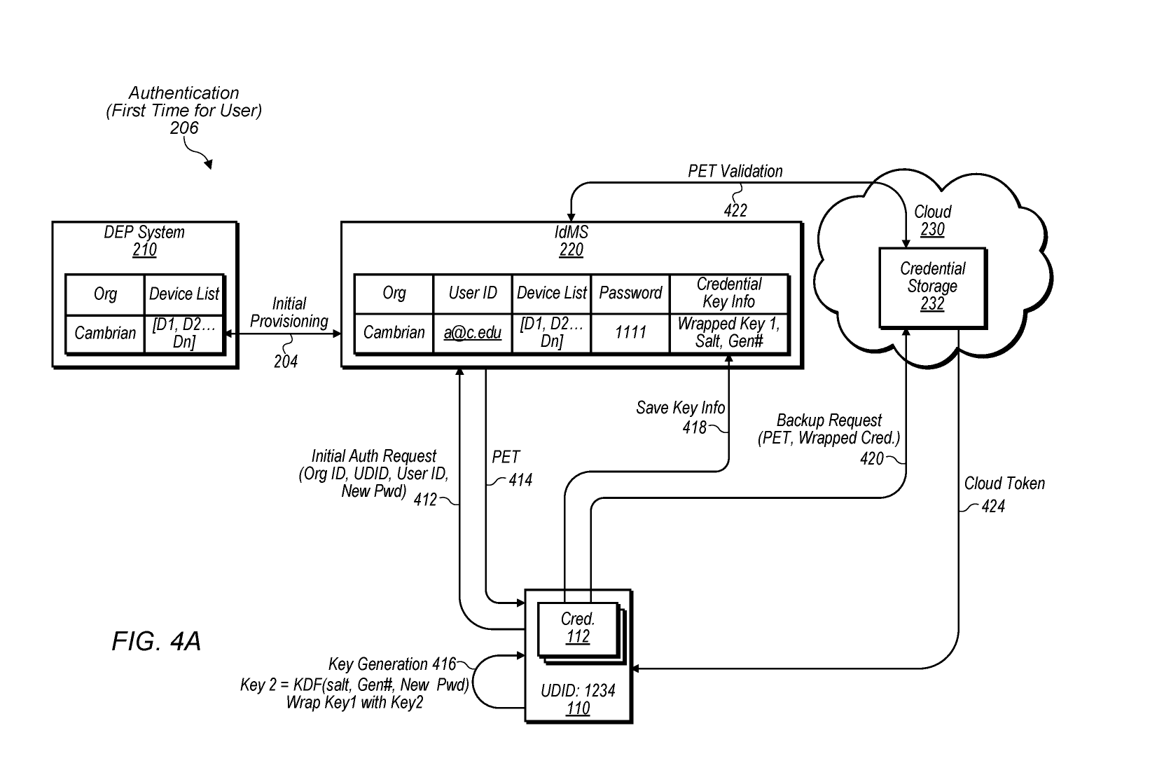

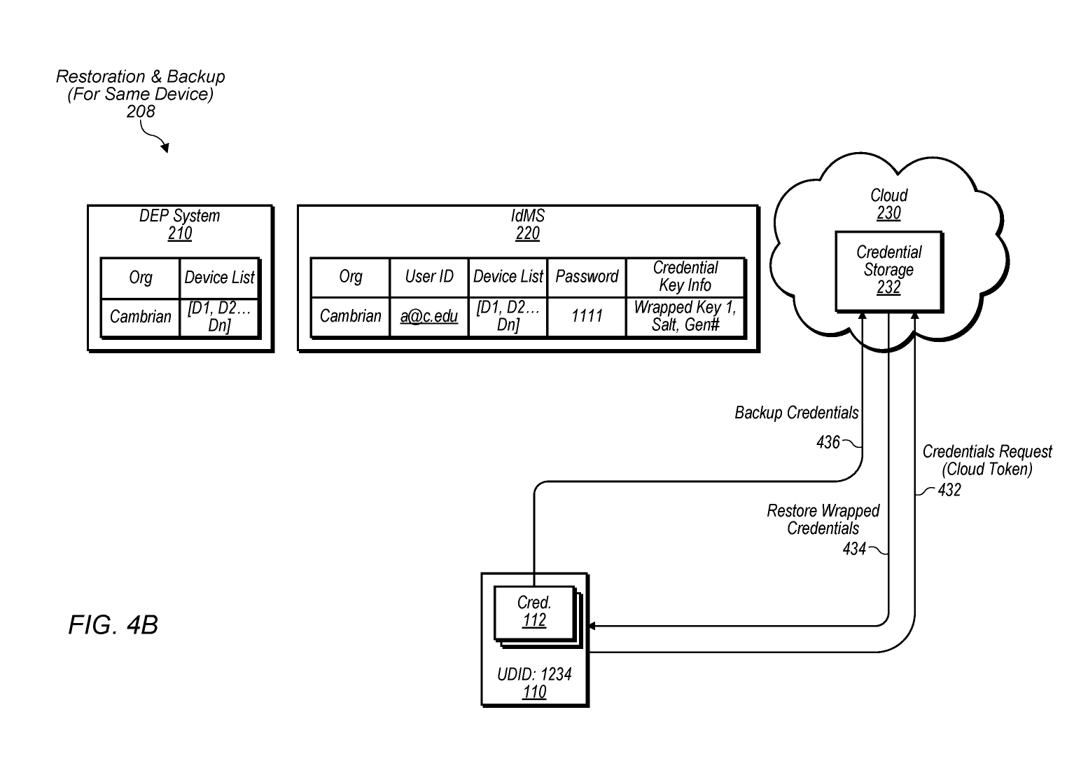

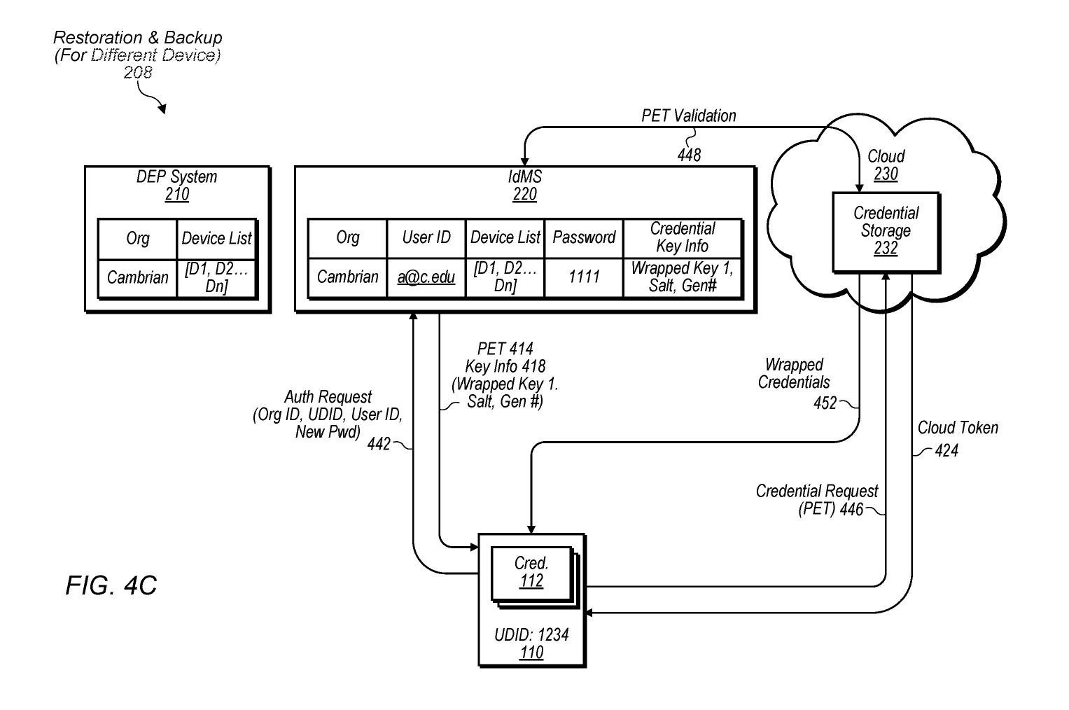

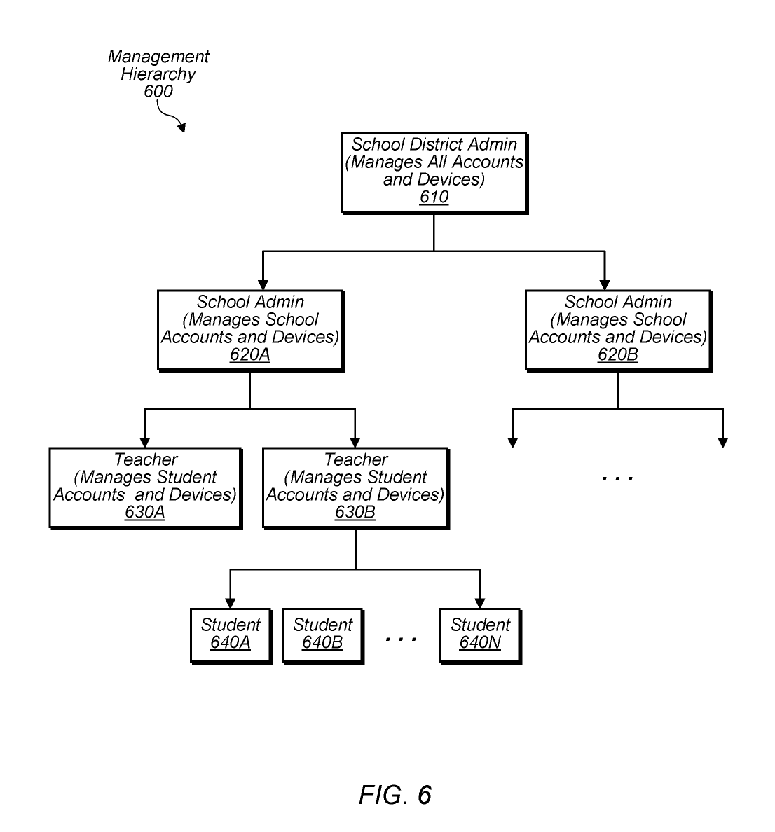

IdMS 220, in one embodiment, is a computer system configured to manage user account information and perform user authentication 206 for accessing credentials 112. In various embodiments, this management includes the initial creation of user accounts and the storage of user authentication information 126 associated with a particular organization identifier 212. As noted above, in some embodiments, information 126 may include user names and/or information indicative of initial passwords specified by organization 120, which presents an additional authentication factor adding further security. When a user later attempts to authenticate using information 126, in various embodiments, IdMS 220 is configured to instruct the user to create a new password that is unknown to organization 120 and complies with the password policies established by organization 120. As noted above, in some embodiments, IdMS 220 may permit a user to use a simpler password because the user is using a registered organization device 110 (as opposed to an unregistered device). For example, in one embodiment, this simpler password may be a four-digit password (as opposed to an eight-character password including alphanumeric and non-alphanumeric characters). In some embodiments, this new password is also simpler than the initial password assigned to the user's account. In various embodiments, IdMS 220 is also configured to allow an organization to revoke or reset a user's account. In some embodiments, administrators at organization 120 may be organized into a hierarchy that dictates which user accounts and devices can be managed by a given administrator as will be discussed below with respect to FIG. 6. Authentication 206 is described in further detail below with respect to FIGS. 3B and 4A.

Cloud 230, in one embodiment, is a cluster of computer systems that perform various services including the restoration and backup 208 of credentials 112. In various embodiments, cloud 230 is configured to store credentials 112 in credential storage 232, which, in some embodiments, includes a collection of hardware security modules (HSMs). (As used herein, the term “hardware security module” is to be interpreted according to its understood meaning in the art, and includes a physical computing device configured to securely store confidential data.) In some embodiments, the HSMs implementing storage 232 comply with the 140 series of Federal Information Processing Standards (FIPS). In some embodiments, the HSMs are configured to store credentials 112 in an encrypted manner using keys maintained by the HSMs. In other embodiments, the HSMs are configured to store the encryption keys usable to decrypt encrypted credentials 112, which may be stored elsewhere in storage 232. Accordingly, in one embodiment, the HSMs maintain private keys used to decrypt credentials 112; the corresponding public keys may be distributed to devices 110, which use the keys to encrypt credentials 112 prior to storage in storage 232. In such an embodiment, an HSM may use the private key to later decrypt credentials 112 before they are provided to a requesting device 110. In some embodiments, the HSMs are configured to limit the number of unsuccessful authentication attempts by a user such that stored information (e.g., the encryption keys) is destroyed upon exceeding the number of permissible attempts. Restoration and backup 208 is described in further detail below with respect to FIGS. 3C and 4B.

Turning now to FIG. 3A, a block diagram of one embodiment of initial provisioning 204 is depicted. As shown, an organization 120, for example, named “Cambrian” may register a device 110 having a UDID of 1234 with DEP system 210. The organization may also specify a particular configuration C for device 110. In the illustrated embodiment, the initial provisioning 204 of device 110 includes DEP system 210 storing an organization token (T) 312 and a configuration profile 314 on the device 110. As noted above, in some embodiments, token 312 may be generated by applying a keyed hash function to the organization identifier “Cambrian” and/or the UDID 1234. In some embodiments, profile 314 may include one or more usage policies and/or password policies for device 110. In the illustrated embodiment, provisioning 204 may also include the creation of user accounts for users that will access device 110 and establish credentials 112. For example, as shown, a user account may have the user name/identifier “me@cambrian.org” and initial password 0527. Although the password 0527 is shown as being stored in IdMS 220 in FIG. 3A, IdMS 220, in various embodiments, is configured to store a verifier derived from the password, as opposed to storing the actual password, which may be less secure. Accordingly, while FIGS. 3B-4C may depict the communication of a password (or “Pwd”) from device 110 to various elements for simplicity, in various embodiments, device 110 actually communicates a verifier derived from the password.

As shown by the dotted box, in some embodiments, all or a portion of provisioning 204 may be handled by a mobile device management (MDM) server 310A or configurator 310B. In one embodiment, MDM server is a server operated by organization 120 and is configured to distribute a profile to a device 110 coupled to the server. In one embodiment, configurator 310B is an application executable by a device 110 to create or download a profile to that device 110.

Turning now to FIG. 3B, a block diagram of one embodiment of authentication 206 is depicted. In the illustrated embodiment, authentication 206 is an initial authentication performed with IdMS 220 in order to establish an initial backup of credentials in credential storage 232. Once established, in some embodiments, subsequent authentications are performed via cloud 230 as will be discussed with FIG. 3C. In other embodiments, such as those discussed with 4A-4C, IdMS 220 may be used to perform authentications for each retrieval of credentials 112.

In the illustrated embodiment, authentication 206 may begin with a user attempting an initial login into a device 110. In such an embodiment, device 110 may collect the user's user id and password (e.g., “me@cambrian.org” and “0527”), and convey the user id and a verifier derived from the password along with the token T in an initial authentication request 322 to IdMS 220. As noted above, this user id and password may be created by an entity other than the user such as organization 120. In various embodiments, IdMS 220 authenticates the user by verifying that the user's id and password match those of an account associated with the organization (e.g., “Cambrian”) and by determining that device 110 is a registered device. As shown, this may include interacting with DEP system 210 in order to perform a verification 324 of the received token T. In some embodiments, verification 324 may include recalculating a token based on the organization identifier and UDID and comparing this token with the received token. Upon successfully authenticating the user, IdMS 220 may issue a cloud token 326 that allows device to back up the user's credentials to credential storage 232. In some embodiments, device 110 is configured to then instruct the user to create a new password different from the initial password. As shown, a verifier derived from this new password may be sent in a backup credential request 328 along with the cloud token and the user id. In response to receiving this request 328 and verifying the cloud token, credential storage 232 may store the user's credentials 112 provided by device 110, so that they can later be retrieved using the user's id and new password.

Turning now to FIG. 3C, a block diagram of one embodiment of restoration and backup 208 is depicted. In the illustrated embodiment, restoration and backup 208 is performed after a user has stored an initial backup of credentials 112 to storage 232. In some embodiments, restoration and backup 208 may be performed in a similar manner regardless of whether the user is using the same device 110 used in authentication 206 or another registered device 110.

As shown, restoration and backup 208 may begin with a request 322 for credentials. In some embodiments, this request 322 includes the token T, the user's id, and a verifier derived from the user's new password as discussed in FIG. 3B. In the illustrated embodiment, cloud 230 is configured to verify the user's identify and interact with DEP system 210 to perform a verification 334 of the token T. If the authentication is successful, storage 232 may provide the requested credentials 336. Otherwise, in some embodiments, storage 232 may deny the request 332 and allow a limited number of retries before destroying the user's credentials 112. Once a user's credentials 112 have been successfully restored to device 110, device 110 may allow the user to access them. If the user later attempts to modify existing credentials or add new ones, device 110 may perform a backup 338 of credentials 112 to storage 232.

In some embodiments, if a request 332 is made for credentials of a user that have not been stored in storage 232, cloud 230 may indicate this to device 110, which may then attempt to perform authentication 206 discussed above with FIG. 3B. In some embodiments, device 110 may also decline to unlock itself until authentication 206 has been successfully completed.

Turning now to FIG. 4A, a block diagram of another embodiment of authentication 206 is depicted. In the illustrated embodiment, authentication 206 is also an initial authentication performed with IdMS 220 in order to establish an initial backup of credentials in credential storage 232. As shown, authentication 206 may begin with an initial authentication request 412, which includes an identifier for organization 120, the device's UDID, the user's id, and a verifier derived from the user's password. Unlike the embodiments depicted in FIGS. 3A and 3B, a token T may not be used, in some embodiments; instead, as shown, provisioning 204 includes the storage of the organization identifier and device list on IdMS 220 in the illustrated embodiment. Accordingly, in such an embodiment, IdMS 220 may verify the organization identifier and UDID in the request with those stored in IdMS 220 in order to confirm device 110 is a registered device 110. IdMS 220 may further verify the user's id and the verifier derived from password in the request in order to authenticate the user of device 110. In response to a successful authentication, IdMS 220 may issue a password equivalent token (PET) 414 usable to backup and restore credentials in storage 232. Device 110 may also instruct the user to create a new password different from the initial password stored on IdMS 220.

In some embodiments, device 110 is configured to “wrap” (i.e., encrypt) credentials stored in storage 232 using an encryption key generated by device 110. For example, in the illustrated embodiment, device 110 is configured to perform a key generation 416 that includes the generation of a first key Key 1 and a second key Key 2. As shown, Key 2 may be generated by applying a key derivation function (KDF) to a salt, a key generation number, and the user's new password. (As used herein, the term “salt” refers to a value (e.g., random data) that is combined with the user's password in order to produce a stronger encryption key.) Key 2 may then be used to wrap Key 1, which is used to encrypt the credentials 112 to be sent to storage 232. Once generated, device 110 may locally save this information 418 and store this information 418 on IdMS 220.

In the illustrated embodiment, device 110 is configured to issue a backup request 420 that includes the PET and wrapped credentials to storage 232, which is configured to store the credentials after performing a validation 422 of the PET. After successfully storing the credentials, storage 232 may issue a cloud token 424 usable to later retrieve the credentials as discussed with FIG. 4B.

Turning now to FIG. 4B, a block diagram of another embodiment of restoration and backup 208 is depicted. In the illustrated embodiment, restoration and backup 208 is performed by the same device that performed the authentication 206 discussed with FIG. 4A. As shown, restoration and backup 208 may begin with issuing a request 432 for credentials 112 to storage 232. This request 432 may include the cloud token 424 discussed above. After storage 232 verifies the token, storage 232 may send the wrapped credentials 434 to device 110, where device 110 unwraps (i.e., decrypts) the credentials using the previously stored key Key 1. If the user later attempts to modify existing credentials or add new ones, device 110 may rewrap the credentials 112 and send them as backup credentials 436.

Turning now to FIG. 4C, a block diagram of another embodiment of restoration and backup 208 is depicted. In the illustrated embodiment, restoration and backup 208 is performed when a user attempts to retrieve credentials 112 from anther device 110 that has not been used previously to retrieve credentials 112 for that user. As shown, restoration and backup 208 may begin with an authentication request 442 that includes an organization identifier, UDID, user id, and a verifier derived from a password. In response to successfully verifying this information, IdMS 220 may issue a password equivalent token (PET) 414 along with the key information 418 discussed above with FIG. 4A. Device 110 may then issue a credential request 446 with the PET to credential storage 232, which may interact with IdMS 220 to perform a PET validation 448. In response to the PET being successfully validated, storage 232 may send the wrapped credentials 452 and a cloud token 424 for use in subsequent retrievals of the credentials 112 from storage 232. Meanwhile, device 110 may recreate Key 2 by applying a key derivation function to the received salt, received generation number, and the user's password. Once obtained, device 110 may unwrap Key 1 and use Key 1 to unwrap the received wrapped credentials 452. If changes are made to the credentials, device 110 may perform a backup to storage 232 as discussed above.

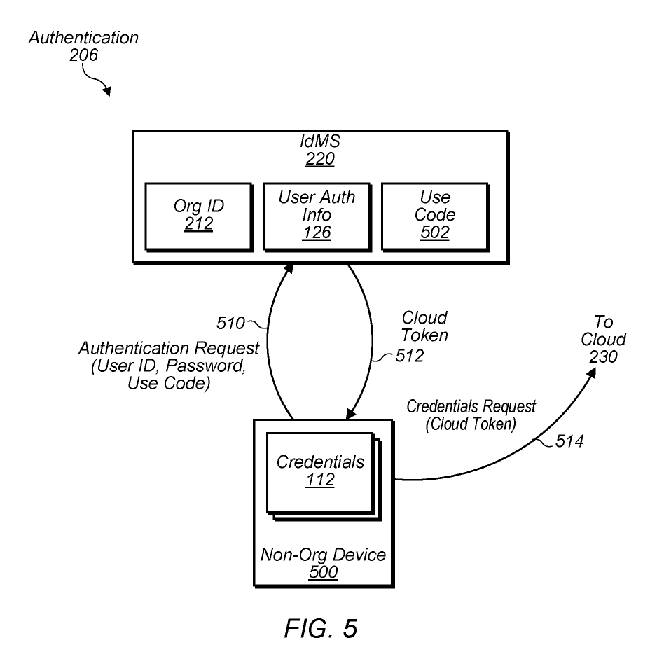

Turning now to FIG. 5, a block diagram of an authentication 206 with a use code for unregistered devices is depicted. As noted above with respect to FIG. 1, in some embodiments, distribution system 10 may interact with devices that are not associated with organization 120 (or, at least have not been registered by organization 120). In such an embodiment, because these devices have not been registered with organization 120, their association with organization 120 cannot be verified as an additional authentication factor providing added security. To account for the lack of this additional factor, an additional use code may be used as an additional factor in some embodiments. Accordingly, in the illustrated embodiment, IdMS 220 is configured to store a use code 502 usable by non-organization device 500 to obtain credentials from cloud 230.

Use code 502, in one embodiment, is a pre-established value associated with an organization identifier 212 (or more generally, the organization specified by identifier 212). In some embodiments, use code 502 may be established such that it is unique to a particular device 500 (or to a particular user account). In the illustrated embodiment, device 500 is configured to issue an authentication request 510 that includes a user id, a verifier derived from a password, and use code 502. IdMS 220 may then authenticate the user by verifying the user's authentication information and use code 502. In some embodiments, the use of use code 502 as an additional authentication factor may also permit a user to use a simpler password as discussed above. In response to a successful authentication, in some embodiments, device 500 is issued a cloud token 512, which is similar to cloud token 326 discussed above with FIG. 3B and used to perform an initial backup of credentials. In some embodiments, device 500 may proceed to restore and back up credentials in a similar manner as discussed above with respect to FIGS. 3C.

Turning now to FIG. 6, a block diagram of a management hierarchy 600 is depicted. As noted above, in some embodiments, user accounts and devices 110 may be managed in accordance with a management hierarchy that establishes the particular devices 110 and users accounts that may be managed by a given administrator based on that administrator's level in the hierarchy. For example, in the illustrated embodiment, management hierarchy 600 is a hierarchy of school administrators for a school district that includes multiple schools. As shown, a school district admin 610 may be at the top level of hierarchy 600 and is permitted manage all accounts and devices associated with the school district. Accordingly, admin 610 may be able to revoke a device 110 used by students 640A-N and reset an account for admin 620B. At the next level, school admins 620A and 620B are permitted to manage accounts and devices at their respective schools, which may include devices and accounts for both students and teachers. At the lowest level, teachers 630A and 630B are permitted to manage devices and accounts for students in their respective classes. Being a hierarchy, a lower level admin is not permitted to manage devices and accounts of higher-level admins. Thus, teacher 630A could not reset the account for admin 620A or reset accounts for students 640A-N of teacher 630B. In some embodiments, credential storage system 100 (or more specifically, IdMS 220) is configure store information defining hierarchy 600 and, in response to receiving a request from an admin to manage a user's account, use the information to verify that the admin has sufficient authority to manage the account. If the admin is confirmed to have the authority, credential storage system 100 may then permit the admin to manage the account. Although the illustrated embodiment pertains to a school district, it is noted that similar hierarchies may be used for other similar structured organizations such as companies, non-profit organizations, government entitles, etc.

Turning now to FIG. 7, a flow diagram of a method 700 is depicted. Method 700 is one embodiment a method for distributing credential information across multiple devices with different password policies. In some embodiments, method 700 is one or more computer systems such as those of credential storage system 100. In some instances, performance of method 700 may allow an organization to better accommodate needs of some users while also addressing security concerns.

In step 710, a storage system stores credential information (e.g., user credentials 112) for multiple users that share multiple devices (e.g., devices 110) associated with an organization (organization 120). In some embodiments, the storage system includes one or more hardware security modules (HSMs) (e.g., those included in credential storage 232) that store the credential information (or store encryption keys used to decrypt credential information stored elsewhere the storage system). The credential information may include any of the examples given above for credentials 112 with respect to FIG. 1 such as transaction account information usable to facilitate a purchase.

In step 720, the storage system receives policy information (e.g., information included in device registration information 122 and stored as configuration information 216) from the organization. In various embodiments, the policy information specifies a first policy and a second policy. The first policy defines criteria for passwords usable by a first set of users in the plurality of users to access the credential information. The second policy defines criteria for passwords usable by a second set of users in the plurality of users to access the credential information. In such an embodiment, the criteria defined by the first policy differ from the criteria defined by the second policy. For example, the first policy may specify that users under the age of seven are allowed to use four-digit passwords, and the second policy may specify that users over the age of seven are required to have password that include at least eight alphanumeric characters.

In step 730, the storage system permits a user of the first set of users to access credential information associated with the user in response to the user presenting a password (e.g., user authentication information 126) that is in accordance with the first policy. In some embodiments, the HSMs discussed with step 710 permit the user to access the credential information associated with the user in response to the user presenting the password that is in accordance with the first policy. In some embodiments, the passwords usable by a first set of users to access the credential information are further usable to log into devices operated by the first set of users.

### Exemplary Computer System

Turning now to FIG. 8, a block diagram illustrating an exemplary embodiment of a device 800 is shown. Device 800 is one embodiment of a computing system that may implement functionality of devices 110 and/or credential storage system 100. In some embodiments, elements of device 800 may be included within a system on a chip (SOC). In some embodiments, device 800 may be included in a mobile device, which may be battery-powered. Therefore, power consumption by device 800 may be an important design consideration. In the illustrated embodiment, device 800 includes fabric 810, processor complex 820, graphics unit 830, display unit 840, cache/memory controller 850, input/output (I/O) bridge 860.

Fabric 810 may include various interconnects, buses, MUX's, controllers, etc., and may be configured to facilitate communication between various elements of device 800. In some embodiments, portions of fabric 810 may be configured to implement various different communication protocols. In other embodiments, fabric 810 may implement a single communication protocol and elements coupled to fabric 810 may convert from the single communication protocol to other communication protocols internally. As used herein, the term “coupled to” may indicate one or more connections between elements, and a coupling may include intervening elements. For example, in FIG. 8, graphics unit 830 may be described as “coupled to” a memory through fabric 810 and cache/memory controller 850. In contrast, in the illustrated embodiment of FIG. 8, graphics unit 830 is “directly coupled” to fabric 810 because there are no intervening elements.

In the illustrated embodiment, processor complex 820 includes bus interface unit (BIU) 822, cache 824, and cores 826A and 826B. In various embodiments, processor complex 820 may include various numbers of processors, processor cores and/or caches. For example, processor complex 820 may include 1, 2, or 4 processor cores, or any other suitable number. In one embodiment, cache 824 is a set associative L2 cache. In some embodiments, cores 826A and/or 826B may include internal instruction and/or data caches. In some embodiments, a coherency unit (not shown) in fabric 810, cache 824, or elsewhere in device 800 may be configured to maintain coherency between various caches of device 800. BIU 822 may be configured to manage communication between processor complex 820 and other elements of device 800. Processor cores such as cores 826 may be configured to execute instructions of a particular instruction set architecture (ISA), which may include operating system instructions and user application instructions. These instructions may be stored in a computer readable medium such as a memory coupled to memory controller 850 discussed below.

Graphics unit 830 may include one or more processors and/or one or more graphics processing units (GPU's). Graphics unit 830 may receive graphics-oriented instructions, such as OPENGL®, Metal, or DIRECT3D® instructions, for example. Graphics unit 830 may execute specialized GPU instructions or perform other operations based on the received graphics-oriented instructions. Graphics unit 830 may generally be configured to process large blocks of data in parallel and may build images in a frame buffer for output to a display. Graphics unit 830 may include transform, lighting, triangle, and/or rendering engines in one or more graphics processing pipelines. Graphics unit 830 may output pixel information for display images.

Display unit 840 may be configured to read data from a frame buffer and provide a stream of pixel values for display. Display unit 840 may be configured as a display pipeline in some embodiments. Additionally, display unit 840 may be configured to blend multiple frames to produce an output frame. Further, display unit 840 may include one or more interfaces (e.g., MIPI® or embedded display port (eDP)) for coupling to a user display (e.g., a touchscreen or an external display).

Cache/memory controller 850 may be configured to manage transfer of data between fabric 810 and one or more caches and/or memories. For example, cache/memory controller 850 may be coupled to an L3 cache, which may in turn be coupled to a system memory. In other embodiments, cache/memory controller 850 may be directly coupled to a memory. In some embodiments, cache/memory controller 850 may include one or more internal caches. Memory coupled to controller 850 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAIVIBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 850 may be any type of non-volatile memory such as NAND flash memory, NOR flash memory, nano RAM (NRAIVI), magneto-resistive RAM (MRAIVI), phase change RAM (PRAM), Racetrack memory, Memristor memory, etc. As noted above, this memory may store program instructions executable by processor complex 820 to cause device 800 to perform functionality described herein.

I/O bridge 860 may include various elements configured to implement universal serial bus (USB) communications, security, audio, and/or low-power always-on functionality, for example. I/O bridge 860 may also include interfaces such as pulse-width modulation (PWM), general-purpose input/output (GPIO), serial peripheral interface (SPI), and/or inter-integrated circuit (I2C), for example. Various types of peripherals and devices may be coupled to device 800 via I/O bridge 860. For example, these devices may include various types of wireless communication (e.g., Wi-Fi, Bluetooth, cellular, global positioning system, etc.), additional storage (e.g., RAM storage, solid state storage, or disk storage), user interface devices (e.g., keyboard, microphones, speakers, etc.), etc.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

Various embodiments described herein may use personal information data about a user. The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

What is claimed is:

1. A computer system, comprising:
one or more processors; and
memory having program instructions stored therein that are executable by the one or more processors to cause the computer system to perform operations including:
storing registration information identifying a plurality of devices as being registered to an organization;
receiving, over a network from a first device, a first request for credential information of a first of a plurality of users associated with the organization;
authenticating the first request, including:
verifying that the first device is being used by the first user; and
determining, based on the registration information, whether the first device is one of the plurality of devices; and
based on the authenticating, granting or denying the first request for the credential information.

2. The computer system of claim 1, wherein the verifying includes receiving a password information of the first user from the first device, wherein the password information is derived from a password usable by the first user to log into the first device.

3. The computer system of claim 1, wherein the credential information includes one or more user names and passwords of the first user.

4. The computer system of claim 1, wherein the operations include:
receiving, from a second device, a second request for credential information of the first user;
authenticating the second request, including:
verifying that the second device is being used by the first user; and
determining, based on the registration information, whether the second device is one of the plurality of devices; and
based on the authenticating of the second request, granting or denying the second request for the credential information.

5. The computer system of claim 1, wherein the operations include:
initializing an account for the first user, wherein the initializing includes creating an initial password for the account;
in response to receiving information indicative of the initial password, instructing the first user to create a new password that is simpler than the initial password; and
authenticating the first request by using the new password to verify that the first device is being used by the first user.

6. The computer system of claim 5, wherein the operations include:
receiving, from the organization, registration information identifying a plurality of users associated with the organization; and
initializing the account for the first user in response to receiving the registration information.

7. The computer system of claim 5, wherein the operations include:
storing different, organization-specified password policies for ones of the plurality of devices, wherein the different password policies identify different criteria for permissible passwords; and
wherein the instructing includes indicating, based on one of the different password policies, a permissible complexity for the new password to the first user.

8. The computer system of claim 1, further comprising:
one or more hardware security modules (HSMs) configured to:
store encryption keys usable to decrypt credential information for the plurality of users including the requested credential information of the first user; and
grant the first request by using one of the stored encryption keys to decrypt the requested credential information to the first device.

9. The computer system of claim 1, wherein the operations include:
storing administration information defining a hierarchical relationship among a plurality of administrators such that a higher-level administrator is able to administer a superset of user accounts that includes a set of accounts administered by a lower-level administrator;
receiving a request from one of the plurality of administrators to reset an account of the first user;
based on the administration information, verifying whether the administrator has authority to administer the account of the first user; and
resetting the account of the first user in response to verifying that the administrator has the authority.

10. The computer system of claim 1, wherein the operations include:
establishing an access code associated with a second device that is not one of the plurality of devices;
receiving, from the second device, a second request for the credential information of the first user;
authenticating the second request, including:
verifying that the second device is being used by the first user; and
confirming that an access code received from the second device matches the established access code; and
based on the authenticating of the second request, granting the second request for the credential information.

11. A computing device, comprising:
one or more processors; and
memory having program instructions stored therein that are executable by the computing device to cause the computing device to perform operations including:
storing information indicative of a first password usable by a first user to access the computing device and information indicative of a second password usable by a second user to access the computing device;
while storing credential information for the first user, issuing a request for credential information of the second user to a remote storage system, wherein the request specifies the information indicative of second password of the second user; and
in response to receiving the credential information of the second user from the storage system, storing the credential information of the second user on the computing device, wherein the credential information of the second user includes information usable to authenticate the second user.

12. The computing device of claim 11, wherein the operations include:
storing an organization token that is usable to verify that the computing device is associated with an organization; and
wherein issuing the request includes providing the organization token to the remote storage system.

13. The computing device of claim 11, wherein the operations include:
receiving, from the first user, an input modifying the credential information for the first user; and
sending the modified credential information to the remote storage system.

14. The computing device of claim 13, wherein the operations include:
generating an encryption key for encrypting the modified credential information; and
using the encryption key to encrypt the modified credential information sent to the remote storage system.

15. The computing device of claim 11, wherein the operations include:
receiving policy information including a first password policy and a second password policy, wherein the first password policy defines password criteria for a first set of users, and wherein the second password policy defines password criteria for a second, different set of users; and
verifying that the first password complies with the first password policy; and
verifying that the second password complies with the second password policy.

16. The computing device of claim 11, wherein the credential information of the second user includes a user name and password usable to authenticate the second user to a website.

17. A method, comprising:
a storage system storing credential information for a plurality of users that share a plurality of devices associated with an organization;
the storage system receiving policy information from the organization, wherein the policy information specifies a first policy and a second policy, wherein the first policy defines criteria for passwords usable by a first set of users in the plurality of users to access the credential information, wherein the second policy defines criteria for passwords usable by a second set of users in the plurality of users to access the credential information, and wherein the criteria defined by the first policy differ from the criteria defined by the second policy; and
the storage system permitting a user of the first set to access credential information associated with the user in response to the user presenting a password that is in accordance with the first policy.

18. The method of claim 17, wherein the storage system includes a plurality of hardware security modules (HSMs) that store the credential information and permit the user to access the credential information associated with the user in response to the user presenting the password that is in accordance with the first policy.

19. The method of claim 17, wherein the passwords usable by a first set of users to access the credential information are further usable to log into devices operated by the first set of users.

20. The method of claim 17, wherein the credential information includes transaction account information usable to facilitate a purchase.
